(19) United States
(12) Patent Application Publication
(10) Pub. No.: US 2025/0153054 A1
(43) Pub. Date: May 15, 2025

(54) POWER MODES OF COMPUTER GAMES

(71) Applicant: Sony Interactive Entertainment LLC, San Mateo, CA (US)

(72) Inventor: Mark Evan Cerny, Los Angeles, CA (US)

(21) Appl. No.: 18/813,795

(22) Filed: Aug. 23, 2024

Related U.S. Application Data
(60) Provisional application No. 63/597,779, filed on Nov. 10, 2023.

(51) Int. Cl. A63F 13/80; A63F 13/533; A63F 13/63; G06F 3/04847

(52) U.S. Cl. CPC A63F 13/80; A63F 13/533; A63F 13/63; G06F 3/04847; A63F 2300/308

(57) ABSTRACT

Techniques are described for selectively implementing power modes of computer games and home video consoles at various levels including low power mode operation.

### FIELD

The present application relates to technically inventive, non-routine solutions that are necessarily rooted in computer technology and that produce concrete technical improvements, and more specifically to power modes of computer games.

### BACKGROUND

Computer games may be played on a variety of platforms, including home video game consoles, PCs, and cloud servers emulating consoles or PCs. As understood herein, in part because such platforms are powered from the electrical grid, heretofore no low power modes of operation. Additionally, though home video game consoles have provided options for power reduction via their system configuration menus, they have not provided options directly related to low power modes for the games that are played on them.

### SUMMARY

As understood herein, home video game consoles may, for various reasons, be subject to power restrictions; there is also value in supporting player preferences with regards to power consumption. As also understood herein, computer games as well as home video game consoles typically do not provide for different power modes and hence do not provide options for low-power performance.

As used herein, “home video game console” means a computer game console that runs off of power supplied via an outlet, and typically displays its images on a television (or alternatively a monitor).

Accordingly, an apparatus includes at least one processor assembly of a home video game console configured to implement presentation of at least one computer simulation on at least one display device in a presentation mode selected according to user selection from among at least one first mode in which the computer simulation is presented at a first frame rate and a first quality, and at least one second mode that is explicitly a low power mode in which presentation of the computer simulation consumes less power than power consumed in the first mode.

The processor assembly may be configured to present on the display device at least one user interface (UI) configured for user selection of any one of the first or second modes.

In some embodiments, the UI describes the low power mode qualitatively. In other embodiments, the UI describes the low power mode relatively. Or, the UI can describe the low power mode in absolute power terms. Yet again, the UI can describe the low power mode in frame rate terms or brightness terms.

In some implementations, the low power mode can be presented on the UI for selection along with selectors for the first modes. In other implementations the low power mode is presented on the UI for selection and no selectors are presented for the first modes.

In some examples the processor assembly can be configured to enable selection of the low power mode as an on/off setting. Or, the processor assembly may be configured to enable selection of the low power mode using a slider.

In example embodiments the display device with a fixed refresh rate, e.g. a TV that only supports 60 Hertz refresh rate. In other embodiments the display device supports a variable refresh rate, e.g. a TV that supports a range of refresh rates from 48 Hertz to 120 Hertz.

The UI can be sourced from a game for a home video game console. In addition or alternatively, the UI can be sourced from system configuration menus of a home video game console.

In implementations consistent with present principles, the UI includes a first UI sourced from system configuration menus of a home video game console and a second UI is sourced from a game for a home video game console, and the second UI configuration varies based on mode selection from the first UI. Or, UI includes a first UI sourced from system configuration menus of a home video game console and a second UI sourced from a game for a home video game console responsive to a first mode selection from the first UI, with the second UI not being presented responsive to a second mode selection from the first UI.

Yet again, a first UI may be sourced from system configuration menus of a home video game console and a second UI sourced from a game for a home video game console, and at least one selection from the second UI has a first meaning responsive to a first mode selection from the first UI and a second meaning responsive to a second mode selection from the second UI.

Furthermore, the processor assembly can be configured to present the computer simulation differently based on selection of the second mode, with presenting the computer simulation differently including at least one of: executing code of the computer simulation to take specific steps to reduce power consumption. Note that power reduction can occur in both software and/or hardware. For example, it may be sufficient for the system and/or game software to reduce power. In addition or alternatively, as a hardware-implemented example the hardware can be downclocked, and the same software will run at lower power. Or both software and hardware power reduction may be used.

In another aspect, an apparatus includes at least one computer medium that is not a transitory signal and that in turn includes instructions executable by at least one processor assembly to configure a game for a home video game console in a low power mode. The game is also configurable to operate in a presentation mode that consumes more power than the low power mode.

In another aspect, a method includes configuring a home video game console in a low power mode, and configuring the home video game console in a presentation mode that consumes more power than the low power mode.

In another aspect, an apparatus includes at least one processor assembly of a server implementing a home video game console configured to implement presentation of at least one computer simulation on at least one display device in a presentation mode selected according to user selection from among at least one first mode in which the computer simulation is presented at a first frame rate and a first quality, and at least one second mode that is explicitly a low power mode in which presentation of the computer simulation consumes less power than power consumed in the first mode.

In another aspect, an apparatus includes at least one processor assembly of a personal computer (PC) configured to implement presentation of at least one computer simulation on at least one display device in a presentation mode selected according to user selection from within the computer simulation software among at least one first mode in which the computer simulation is presented at a first frame rate and a first quality, and at least one second mode that is explicitly a low power mode in which presentation of the computer simulation consumes less power than power consumed in the first mode.

In another aspect, an apparatus includes at least one processor assembly of a server implementing a personal computer (PC) configured to implement presentation of at least one computer simulation on at least one display device in a presentation mode selected according to user selection from within the computer simulation software from among at least one first mode in which the computer simulation is presented at a first frame rate and a first quality, and at least one second mode that is explicitly a low power mode in which presentation of the computer simulation consumes less power than power consumed in the first mode.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example consistent with present principles;

FIG. 2 illustrates a first computer simulation system consistent with present disclosure;

FIG. 3 illustrates a second computer simulation system consistent with present disclosure;

FIG. 4 illustrates a processor assembly accessing both system settings and computer game settings;

FIG. 5 illustrates an example presentation mode architecture;

FIG. 6 illustrates an example presentation mode selection user interface (UI);

FIG. 7 illustrates another example presentation mode selection UI;

FIG. 8 illustrates still another example presentation mode selection UI;

FIG. 9 illustrates yet another example presentation mode selection UI;

FIG. 10 illustrates another example presentation mode selection UI;

FIG. 11 illustrates an example consistent with FIG. 4;

FIG. 12 illustrates example logic in example flow chart format consistent with present principles;

FIG. 13 illustrates another example logic in example flow chart format consistent with present principles for reducing power;

FIG. 14 illustrates example logic in example flow chart format consistent with present principles for presenting only selected game options;

FIG. 15 illustrates an game-side presentation mode selection UI tied to a selection of a mode from the system settings;

FIG. 16 illustrates example logic in example flow chart format consistent with present principles for modifying power strategy;

FIG. 17 illustrates an example machine learning (ML) model architecture for outputting power settings in response to, e.g., selection of a low power mode; and

FIG. 18 illustrates example logic in example flow chart format for training the ML model in FIG. 17.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

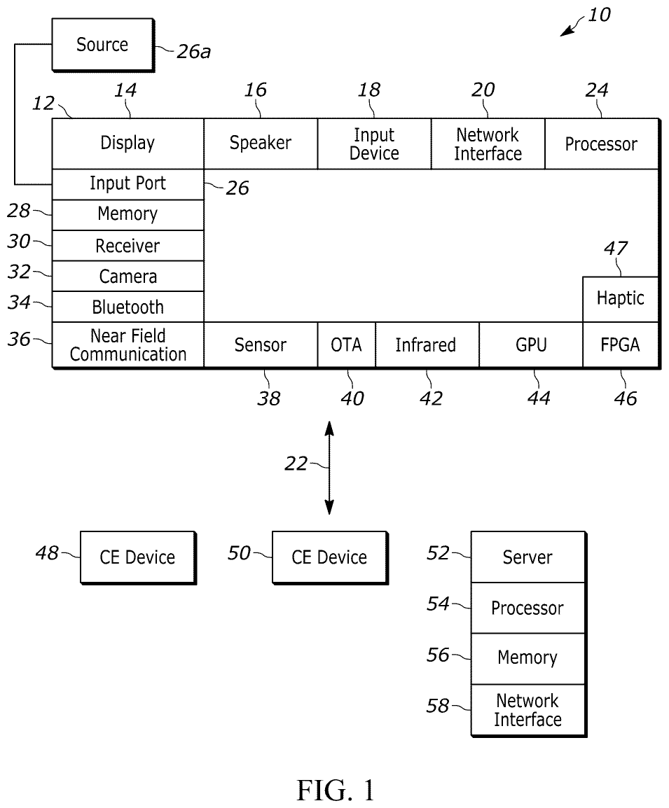

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console such as a Sony PlayStation® or Microsoft Xbox® may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions. A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Large language models (LLM) such as generative pre-trained transformers (GPTT) and stable diffusion (SD) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

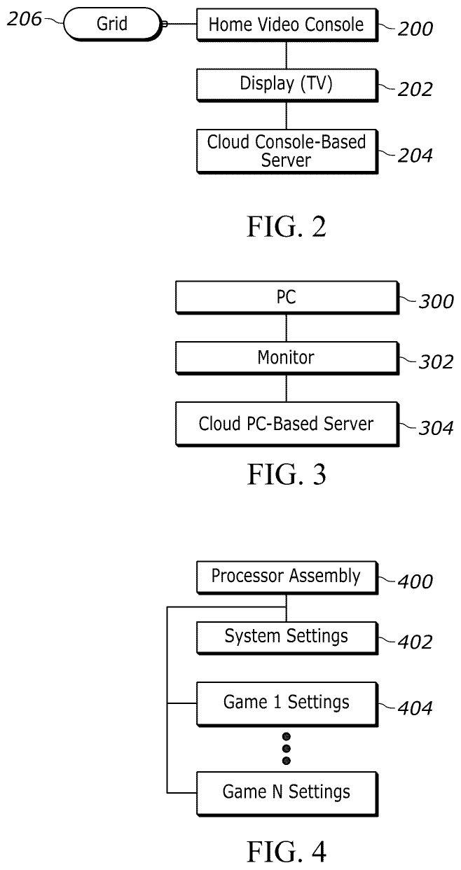

Now refer to FIG. 2. A home video game console 200 may source a computer simulation such as a computer or video game for presentation on a display 202 such as a TV display that is limited to presenting video at only specific frame rates such as 60 (FPS) frames per second, or at only 60 FPS or 120 FPS. Although most TVs today only support specific frame rates such as 60 FPS, some support Variable Refresh Rate (VRR) and can display new images at whatever rate they arrive (within limits, e.g., 48 to 120 frames per second). There are special power reduction strategies for VRR displays, e.g. if a game has a mode to support such a display, and the system then downclocks the GPU to save power, the game can automatically adjust its frame rate downwards.

Likewise, computer simulations may be sourced from a cloud server 204 that is based on game console hardware/software for presentation on the display 202.

A “home video game console” or simply “console” may be a computerized appliance (console) that typically runs off power from an outlet 206, and displays images on a television (or alternatively a monitor). This is in distinction to a portable gaming device which refers to several types of devices, all of which have a battery that allow them to be used anywhere, though also may potentially be connected to an outlet and used.

FIG. 3 on the other hand illustrates a personal computer (PC)-based system in which a PC 300 (including a tower PC and a laptop PC) presents computer simulations on a computer monitor 302, potentially at a variable refresh rate. Likewise, computer simulations may be sourced from a cloud server 304 that is based on PC hardware/software for presentation on the monitor 302. Generically, the display 202 and monitor 302 may be referred to as “display devices”.

FIG. 4 illustrates that a processor assembly 400 can access settings 402 of the system of a home video game console, and also settings 404 of one or more computer games, for purposes to be shortly disclosed.

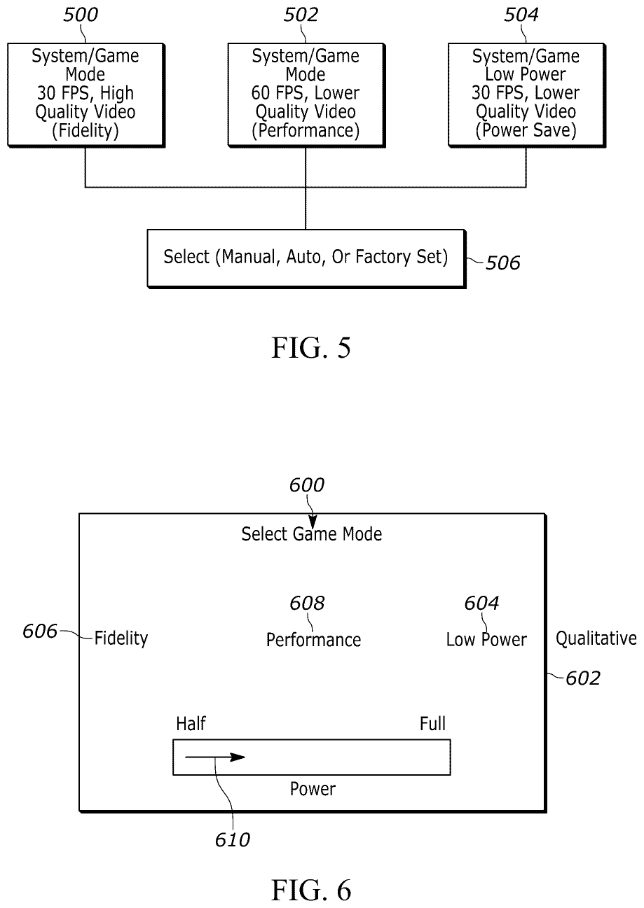

FIG. 5 illustrates various presentation modes for computer simulations such as computer games that may be implemented based on one or both of home video game console system settings and game settings. First modes 500 and 502 are shown, along with second mode 504. In this example, the mode 500 is a fidelity mode in which a computer simulation runs at a relatively low frame rate (e.g., a game-dependent frame rate that might be 30 FPS) and high quality (e.g., a game-dependent rendering resolution that might be 3840×2160); the mode 502 is a performance mode in which the computer simulation runs at a relatively high frame rate (e.g., a game-dependent frame rate that might be 60 FPS) and lower quality (e.g., a game-dependent rendering resolution that might be 1920×1080) than mode 500.

As illustrated in FIG. 5, a mode 504 is explicitly a low power mode that consumes less power than consumed in either of the first two modes. More than one low power mode may be provided, e.g., a low power and very low power mode may be provided. A selector 506 may be implemented to enable selection of one of the presentation modes for presenting a computer simulation, in a variety of ways, e.g. the selection might default to a factory setting, or the selection might be made manually, or a selection in the system settings might automatically force a selection in the game settings.

Low power mode options may be dependent on the display type, e.g. a user of a variable refresh rate (VRR) display may be provided selection for a VRR Low Power mode. As described elsewhere herein, a user may select a low power mode from the set of modes available within a game, e.g., Fidelity, Performance, Low Power Fidelity and Low Power Performance as options, Fidelity, Performance, Low Power and Ultra-Low Power as options, and Fidelity, Performance, Low Power 60 fps and Low Power VRR as options.

The user may select to use a low power mode from the home video game console's UI (e.g., select “Low Power” or “Ultra-Low Power” in a System menu), in which case the game itself may only present options that match the selection in the home video game console's UI. So for example, in the first example above, the game UI only shows the Low Power Fidelity and Low Power Performance options if the user selected “Low Power” in a System menu of the home video game console. Note that a game can bypass user selection if there is only one option that matches the selection or selections in the home video game console's UI, such that in the second example, the game automatically uses Low Power mode if the user selected “Low Power” in the System menu of the home video game console, or automatically uses Ultra-Low Power if the user selected “Ultra-Low Power” in the system menu. In the third example above, the game might automatically uses Low Power VRR if the user selected both “Low Power” and “VRR” in the System menu of the home video game console.

Alternatively, a separate selection from the game options may be “Low Power”, and the meaning of “Fidelity Mode” is now changed, e.g., it is always 30 frames per second but with Low Power not selected it is high quality graphics, and with Low Power selected it is lower quality graphics. The “Performance Mode” meaning could also change accordingly.

Refer now to FIG. 6, which illustrates a presentation selection user interface (UI) 600 that may be presented on any display 602 such as any display described herein. The UI 600 includes a low power mode selector 604 to establish a low power mode consistent with disclosure herein. The low power mode selector 604 may appear alone on the UI 600, or it may appear as shown along with additional selectors 606, 608, e.g. to provide a choice between fidelity, performance and low power presentation modes as described herein. Low power mode selection may be toggled between on and off by toggling the selector 604, and/or it may be established using a slide 610 that may be slid by means of a cursor to cause a power target to vary continuously along a function such as a linear function. In the example of FIG. 6, the low power mode is described qualitatively (“low power”). Additional low power mode selectors (e.g., ultra low power) may be provided.

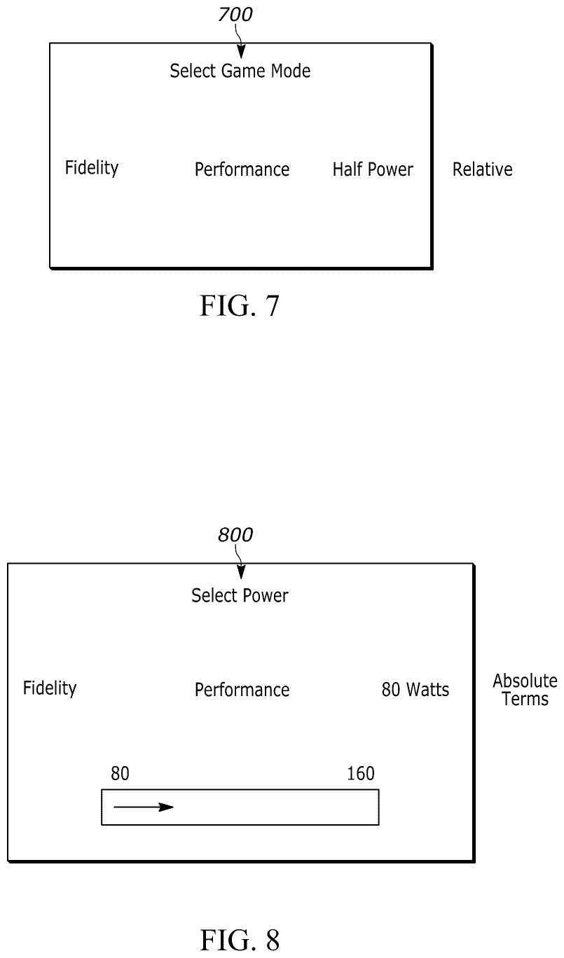

FIG. 7 illustrates a UI 700 that in all essential respects is identical to that of FIG. 6 except that the low power mode is described in the UI relatively (half power).

FIG. 8 illustrates a UI 800 that in all essential respects is identical to that of FIG. 6 except that the low power mode is described in the UI in absolute terms (by target power ceiling such as 80 watts).

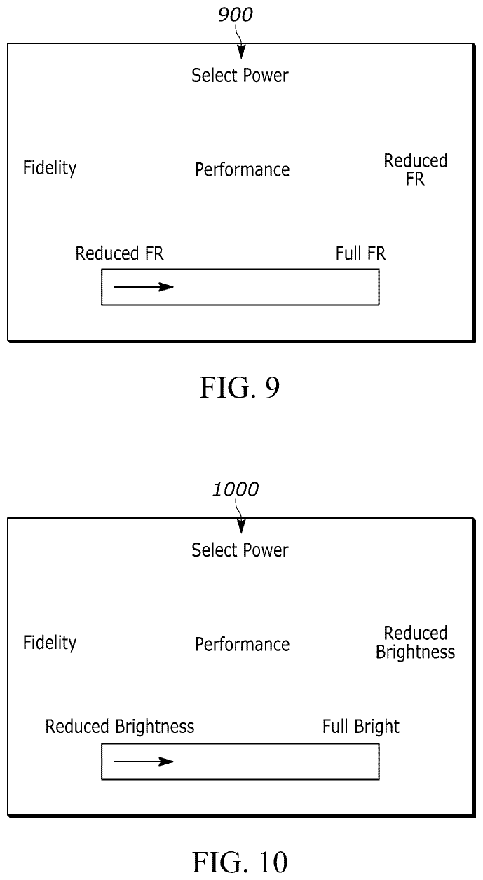

FIG. 9 illustrates a UI 900 that in all essential respects is identical to that of FIG. 6 except that the low power mode is described in the UI 900 in terms of frame rate.

FIG. 10 illustrates a UI 1000 that in all essential respects is identical to that of FIG. 6 except that the low power mode is described in the UI 1000 in terms of display brightness.

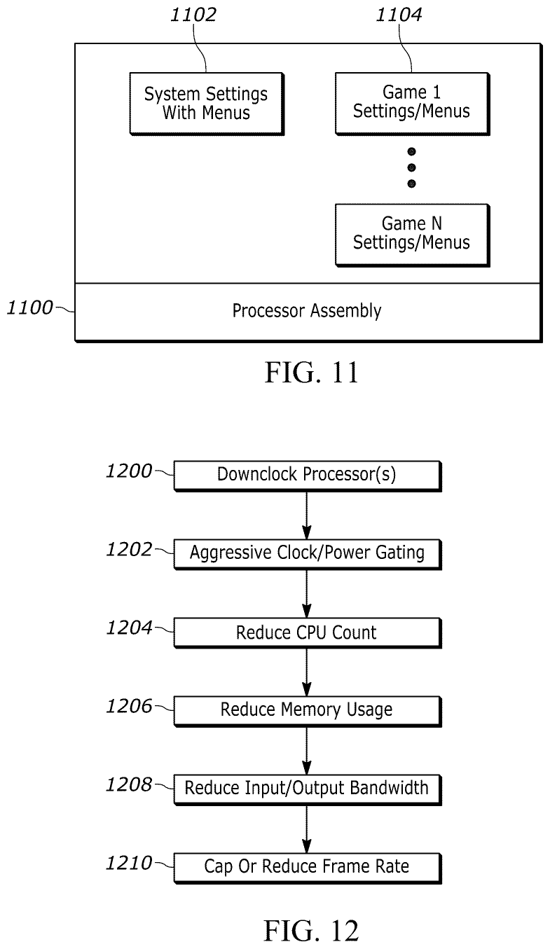

FIG. 11 illustrates a processor assembly 1100 accessing both system settings 1102 with menus (UIs) and one or more computer game settings with menus 1104.

FIG. 12 illustrates various techniques that may be implemented to establish a low power mode. Any one or more of the blocks in FIG. 12 may be implemented in any desired combination.

Bloc 1200 indicates that one or more processors such as GPUs and CPUs, along with internal buses, or external buses may be downclocked. Block 1202 indicates that more aggressive clock gating and power gating of CPU and GPU may be employed when the processors are temporarily inactive.

Block 1204 represents that CPU count can be reduced and power gating of unused CPUs implemented.

Block 1206 indicates that memory usage may be reduced and external memory such as RAMs deenergized.

Block 1208 represents that input/output (I/O) bandwidth, such as reads from a solid sate drive (SSD), may be reduced.

Block 1210 indicates that frame rate may be capped, for instance, by prohibiting frame rates faster than a ceiling rate even if the system capable of doing so.

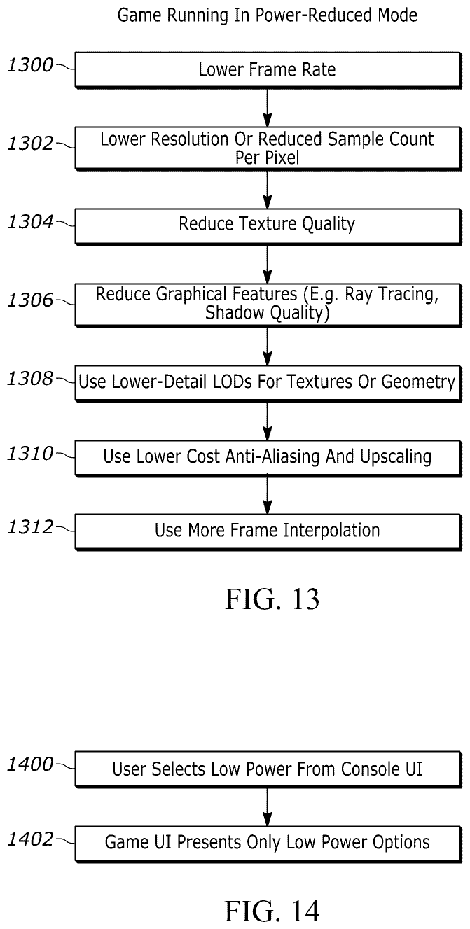

FIG. 13 illustrates that a computer simulation such as a computer game running in a reduced or low power mode may be different from its running in other modes in terms of having lower frame rate 1300, lower resolution or reduced sample count per pixel 1302, reduction in texture quality 1304, e.g. removal of anisotropic filtering, and elimination or reduction of certain graphical features or effects 1306, e.g., removal of ray tracing, reduction of shadow quality. Block 1308 further indicates that the simulation may use lower-detail LODs for textures or geometry, and block 1310 indicates the game may use lower cost strategies for anti-aliasing and upscaling. Block 1312 indicates that the game may make more aggressive use of frame interpolation.

Power reduction can be approximate (e.g., game creators can provide a game mode in which a GPU is downclocked to a specific frequency) or more exact (in which power may be measured and GPU frequency may be adjusted up or down to match the targeted power).

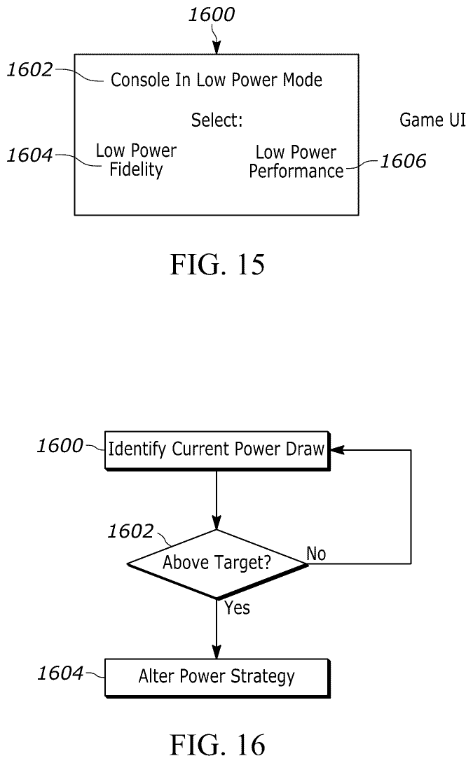

FIG. 14 illustrates that consistent with disclosure herein, at block 1400 a user may select a low power mode from a UI provided by the system (such as the operating system of a home video game console), and at block 1402 a UI provided by the game itself may be presented in reaction to the selection at block 1400. This is reflected in FIG. 15, in which a game UI 1600 indicates at 1602 that a low power mode was selected from the home video game console system and accordingly presents only a low power fidelity mode selector 1604 and a low power performance selector 1606.

FIG. 16 illustrates that when there are specific power targets (e.g. 80 Watts), a feedback loop may be entered in which, at state 1600, currently consumed power is identified and at state 1602 determined if it exceeds the power target, which power strategy being changed at block 1604 accordingly. For example, GPU frequency can be increased if consumed power is below target power and decreased if above target.

If many games are supporting a low power mode, then a lower power consumption console may be provided that plays the games in the low power mode. Thus, a home video game console may be provided with a similar feature set to those described herein, designed to operate at lower power to support games that have support for in-game lower power modes or support for a lower power selection in the system menus.

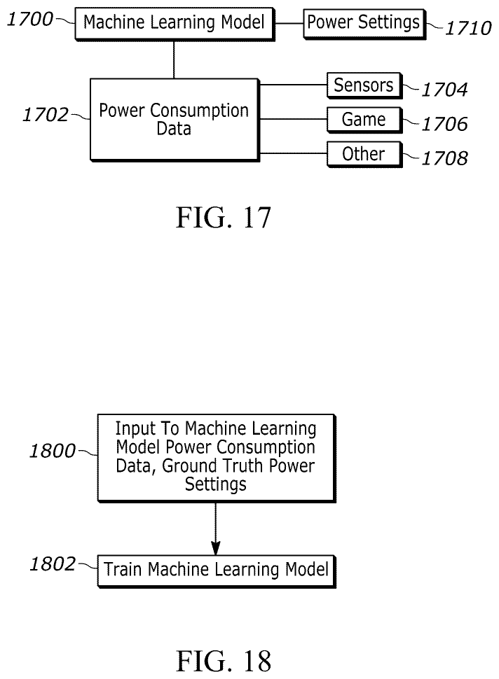

FIGS. 17 and 18 illustrate that machine learning (ML) may be used to implement present techniques. A ML model 1700 may receive power consumption data 1702 as received from a variety of sources, including power/voltage/current sensors 1704 associated with a home video game console, a computer game 1706, and other sources 1708 such as user preferences, user demographics, console type, game type, network congestion data, received power cap target setpoints, etc. Responsive to the input power consumption data 1702, the ML model outputs power settings 1710. The settings 1710 may be automatically implemented, or a recommendation may be presented to the user via a UI to establish a particular presentation mode such as a low power mode.

FIG. 18 illustrates that for training, power consumption data is input to the ML model along with ground truth power settings at block 1800 to train the ML model at block 1802, in one non-limiting training example.

While particular techniques are herein shown and described in detail, it is to be understood that the subject matter which is encompassed by the present application is limited only by the claims.

What is claimed is:

1. An apparatus comprising:
at least one processor assembly of a home video game console configured to:
implement presentation of at least one computer simulation on at least one display device in a presentation mode selected according to user selection from among at least:
at least one first mode in which the computer simulation is presented at a first frame rate and a first quality; and
at least one second mode that is explicitly a low power mode in which presentation of the computer simulation consumes less power than power consumed in the first mode.

2. The apparatus of claim 1, wherein the processor assembly is configured to present on the display device at least one user interface (UI) configured for user selection of any one of the first or second modes.

3. The apparatus of claim 2, wherein the UI describes the low power mode qualitatively.

4. The apparatus of claim 2, wherein the UI describes the low power mode relatively.

5. The apparatus of claim 2, wherein the UI describes the low power mode in absolute power terms.

6. The apparatus of claim 2, wherein the UI describes the low power mode in frame rate terms.

7. The apparatus of claim 2, wherein the UI describes the low power mode brightness terms.

8. The apparatus of claim 2, wherein the low power mode is presented on the UI for selection along with selectors for the first and second modes.

9. The apparatus of claim 2, wherein the low power mode is presented on the UI for selection and no selectors are presented for the first and second modes.

10. The apparatus of claim 2, wherein the processor assembly is configured to enable selection of the low power mode as an on/off setting.

11. The apparatus of claim 2, wherein the processor assembly is configured to enable selection of the low power mode using a slider.

12. The apparatus of claim 2, wherein the UI is sourced from a game for a home video game console.

13. The apparatus of claim 2, wherein the UI is sourced from system configuration menus of the home video game console.

14. The apparatus of claim 2, wherein the UI comprises a first UI sourced from system configuration menus of a home video game console and a second UI sourced from a game for a home video game console, and the second UI configuration varies based on mode selection from the first UI.

15. The apparatus of claim 2, wherein the UI comprises a first UI sourced from system configuration menus of a home video game console and a second UI sourced from a game for a home video game console responsive to a first mode selection from the first UI, the second UI not being presented responsive to a second mode selection from the first UI.

16. The apparatus of claim 2, wherein the UI comprises a first UI sourced from system configuration menus of a home video game console and a second UI sourced from a game for a home video game console, and at least one selection from the second UI has a first meaning responsive to a first mode selection from the first UI and a second meaning responsive to a second mode selection from the second UI.

17. The apparatus of claim 1, wherein the processor assembly is configured to:
present the computer simulation differently based on selection of the second mode, presenting the computer simulation differently comprising at least one of: executing code of the computer simulation to take specific steps to reduce power consumption, modifying hardware configuration to reduce power consumption.

18. An apparatus comprising:
at least one computer medium that is not a transitory signal and that comprises instructions executable by at least one processor assembly to:
configure a game for a home video game console in a low power mode, the game also being configurable to operate in a presentation mode that consumes more power than the low power mode.

19. A method, comprising:
configuring a home video game console in a low power mode; and
configuring the home video console in a presentation mode that consumes more power than the low power mode.

20. An apparatus comprising:
at least one processor assembly of a server implementing a home video game console, the processor assembly being configured to:
implement presentation of at least one computer simulation on at least one display device in a presentation mode selected according to user selection from among at least:
at least one first mode in which the computer simulation is presented at a first frame rate and a first quality; and
at least one second mode that is explicitly a low power mode in which presentation of the computer simulation consumes less power than power consumed in the first mode.

21. The apparatus of claim 20, wherein the second mode is established using a selector explicitly indicating low power mode, or a slider selecting power, and appearing in a user interface (UI) separate from other options.

22. An apparatus comprising:
at least one processor assembly of a personal computer (PC), the processor assembly being configured to:
implement presentation of at least one computer simulation on at least one display device in a presentation mode selected according to user selection from within the computer simulation software from among at least:
at least one first mode in which the computer simulation is presented at a first frame rate and a first quality; and
at least one second mode that is explicitly a low power mode in which presentation of the computer simulation consumes less power than power consumed in the first mode.

23. An apparatus comprising:
at least one processor assembly of a server implementing a personal computer (PC), the processor assembly being configured to:
implement presentation of at least one computer simulation on at least one display device in a presentation mode selected according to user selection from within the computer simulation software from among at least:
at least one first mode in which the computer simulation is presented at a first frame rate and a first quality; and
at least one second mode that is explicitly a low power mode in which presentation of the computer simulation consumes less power than power consumed in the first mode.

24. An apparatus, comprising:
a lower power consumption home video game console that plays video games in a low power mode such that the home video game console operates at relatively lower power to support video games that have support for in-game lower power modes or support for a lower power selection in home video game console system menus.
